(19) United States
(12) Patent Application Publication
(10) Pub. No.: US 2026/0096668 A1
(43) Pub. Date: Apr. 9, 2026

(54) SMART CPR EXHAUST VALVE AND METHOD

(71) Applicant: KAP MEDICAL, INC., CORONA, CA (US)

(72) Inventors: RAJ K. GOWDA, CORONA, CA (US); DANIEL F. ROSENMAYER, CORONA, CA (US); DAVID DARWIN LEWIS, FALLBROOK, CA (US)

(21) Appl. No.: 18/909,351

(22) Filed: Oct. 8, 2024

(51) Int. Cl. A47C 27/08; A61H 31/00; F16K 24/04

(52) U.S. Cl. CPC A47C 27/081; A61H 31/008; F16K 24/04; A61H 2201/0103; A61H 2201/0146

(57) ABSTRACT

The present disclosure relates to a manually actuatable exhaust valve, coupled to an inflatable support surface that includes a position sensor that sends a signal to a controller indicating whether the manually actuatable exhaust valve is open or closed. In response to a signal indicating that the manually actuatable exhaust valve is open, the controller automatically shuts off a fluid source to the inflatable support surface.

### BACKGROUND

The present disclosure relates generally to fluid-inflatable support surfaces and bed systems for supporting the weight of a user particularly for therapeutic and medical applications and to exhaust valves that deflate fluid support surfaces to allow cardiopulmonary resuscitation (CPR) or other lifesaving actions to occur on the support surface.

Both patients and patient service providers benefit from products that provide features that increase therapeutic effectiveness, provide greater patient comfort and/or reduce patient cost. Part of the patient care services provided by patient service providers includes the administering of certain therapies while a patient is in bed. Such therapies include those that are directly related to the damage caused to the skin of a patient due to long periods of time spent in bed. For example, moving a patient, while in bed, can help prevent, as well as cure, bed sores (decubitus ulcers). In addition, reducing the pressure and alleviating pressure points that a bed or support surface exerts on a patient's skin can also help prevent, or cure, bed sores. This can be achieved, for example, by providing an inflatable mattress where the weight of a patient can be distributed over a wider area and therefore the pressure on the patient’s skin can be greatly reduced, as compared with the pressures exerted by conventional mattresses. The reduced pressure allows greater blood supply to the patient’s skin and thus helps to avoid capillary occlusion and the potentially resulting bed sores. Further, even greater pressure relief may be achieved where the mattress contains multiple inflatable cells and where the pressure in each cell, or group of cells, can be independently controlled.

Additional therapies that may be provided to a patient while the patient is in bed, include, for example, those therapies related to treating respiratory complications, such as pulmonary therapy, alternating therapy, pulsation therapy, low air loss therapy, static pressure therapy or the like. Such therapies may require the movement of the patient while in bed for the purpose of loosening up fluids in the patient’s lungs. With these therapies, the weight of the patient may be shifted to help loosen up such fluids. Beds or mattresses containing inflatable cells may be used to allow for controlled inflation and deflation of selected cells for the purpose of assisting patient service providers in shifting the weight of the patient.

To provide a flat surface for administering cardiopulmonary resuscitation (CPR) when necessary, some fluid-inflatable support systems or products have motor driven exhaust fluid valves, such as valves with stepper motors, that are in a body of a controller housing, inaccessible to a user, to exhaust fluid from the support surface when a care giver presses a button on the controller housing. Although such systems are effective, they can be costly.

Other existing fluid-inflatable support systems or products have typically relied on manual disconnection of a hose(s) to deflate the support product and provide a flat surface for administering cardiopulmonary resuscitation (CPR) when necessary. Although a variety of connector designs have been made which emphasize fast decoupling of the control unit from the support product, these designs have generally relied on a patient’s weight being sufficient to force the fluid out of the interior of the support product, which may delay application of CPR until the patient is firmly on the flat surface. Fluid-inflatable support products or bed systems have been constructed which rely on a manual spring-loaded valve that is opened when a handle portion of the CPR valve is rotated. However, current support surfaces that employ a manual CPR valve which has to be activated or deactivated manually also requires that the caregiver has to turn off the fluid supply control unit in order to stop fluid supply to the inflatable mattress. If the fluid supply unit is not turned off, once the CPR valve is manually activated, the support surface will not fully deflate the support surface because the fluid supply control unit is still on and will continuously supply fluid to the support surface. This will not deflate the mattress and the caregiver will not be able to properly administer CPR to the patient. Time is at the essence if a patient goes into cardiac arrest, every minute is valuable to the patient.

Thus, there is a need in the art for an improved support surface with an exhaust fluid valve, such as a CPR valve, to deflate the fluid-filled support or bed system for a user or patient.

### BRIEF DESCRIPTION OF THE DRAWINGS

The accompanying drawings, which are incorporated herein and constitute part of this specification, illustrate exemplary embodiments of the disclosure, and, together with the general description given above and the detailed description given below, serve to explain the features of the disclosure.

FIG. 1 is a diagram illustrating a perspective view of an example support system, such as a bed, according to an embodiment of the present disclosure;

FIG. 2 is a block diagram illustrating an example support system according to an embodiment of the present disclosure;

FIG. 3 is an exploded view of an example manually actuatable fluid exhaust valve, such as a CPR valve, according to an embodiment of the present disclosure;

FIG. 4 is a perspective view of an example manually actuatable fluid exhaust valve and sensor connector cable according to an embodiment of the present disclosure;

FIG. 5 is a flow chart illustrating an example method for controlling an inflatable support apparatus according to an embodiment of the present disclosure;

FIG. 6 is a flow chart illustrating an example method for controlling an inflatable support apparatus according to an embodiment of the present disclosure;

FIG. 7 is a block diagram illustrating an example system according to an embodiment of the present disclosure;

FIG. 8 is a block diagram illustrating an example system according to an embodiment of the present disclosure;

FIG. 9 is a perspective view of a manually actuatable fluid exhaust valve according to an embodiment of the present disclosure;

FIG. 10 is a perspective view of a manually actuatable fluid exhaust valve and sensor connector cable according to an embodiment of the present disclosure;

FIG. 11 is a perspective view of a manually actuatable fluid exhaust valve and sensor connector cable according to an embodiment of the present disclosure;

FIG. 12 is a perspective view of a manually actuatable fluid exhaust valve and sensor connector cable according to an embodiment of the present disclosure; and

FIG. 13 is a cross-sectional view of a manually actuatable fluid exhaust valve according to an embodiment of the present disclosure; and

FIG. 14 is an exploded view of a wireless example of a manually actuatable fluid exhaust valve according to an embodiment of the present disclosure.

### DETAILED DESCRIPTION OF THE PREFERRED EMBODIMENT

The present disclosure relates to a type of smart CPR exhaust valve for therapeutic support surfaces that automatically detects the manual activation or manual deactivation of the CPR exhaust valve and either turns off the fluid supply or turns on the fluid supply to the support surface. Therapeutic support surfaces include, but are not limited to, integrated bed frames, transfer chairs, transfer trolleys, tables, mattresses, pads, patient transfer tables, wheelchair pads, geriatric chair pads, stationary chair pads or any suitable surface which supports a patient. Such products can use the smart CPR valve to also automatically activate rapid deflation or inflation of the above listed products to provide a hard surface under the patients so the health care professionals can administer CPR or can inflate the support surface to provide therapeutic support to the patients.

In some disclosed implementations once the manually activated CPR valve is activated, the valve deflates the support surface and the valve electronics will send a signal to a controller, such as a microcontroller to immediately shut off the fluid supply to the therapeutic support surface which supports a patient by the fluid supply control unit. Once the control unit shuts off the fluid supply, the CPR valve will more effectively deflate the mattress to atmosphere.

In some implementations, once the CPR valve is deactivated (e.g., closed) the valve electronics send a signal to the controller to automatically and immediately start the fluid supply to the therapeutic support surfaces, wherein such surfaces may include all bed frames with inflatable support surfaces, transfer chairs, transfer trolleys, or tables, mattresses, pads, patient transfer tables, wheel chairs pads, geriatric chair pads, chair pads any surface which supports a patient by the fluid supply control unit. The support surface inflates to provide therapeutic support to the patient.

In some implementations, during support surface setup or during normal operation with the patient on the support surface, the control unit will provide an audio-visual alarm on the display panel to the technician or the caregiver if the smart CPR valve was inadvertently or accidently activated while the patient was on the support surface. If the smart CPR valve is inadvertently activated the support surface will deflate and the patient will end up on the deflated support surface thus not providing any clinical therapy to the patient.

A fluid-inflatable support system supports the weight of a user of the support surface, such as a human individual. In some implementations the support system includes a series of inflatable cells. In other implementations a single cell structure is employed, however any suitable inflatable support surface may be used. The present disclosure provides a manually activated exhaust valve design that provides for more rapid deflation/evacuation of the support system in addition to inflation. The design of the support system of the present disclosure allows, for example, rapid evacuation of the support system for immediate commencement of cardio-pulmonary resuscitation (CPR) to a user or patient. This is important because of the urgency in administering the CPR procedure, which may require a solid surface. By operation of the valve positions sensor on the manually actuated CPR valve, the fluid flow generating device automatically and quickly shuts off to effect faster evacuation of fluid from the support compared to prior systems.

According to a broad aspect of the present disclosure, a manually actuatable exhaust valve device or apparatus is provided that includes a position sensor that sends a signal to a controller indicating whether the manually actuatable exhaust valve is open or closed. According to some embodiments of the present disclosure, a fluid exhaust valve includes an exhaust valve housing that includes a manually rotatable member and a fixed member. In some implementations, the fixed member is configured to couple with a plurality of fluid tubes of an inflatable support structure. The manually rotatable member is rotatable relative to the fixed member about a rotation axis and has at least one fluid output port configured to release fluid from the plurality of fluid tubes in response to rotation of the rotary member causing an open valve position. The exhaust valve housing also includes a valve state position sensor operative to provide a signal in response to movement of the manually rotatable member indicating an open valve position and deflation action for the inflatable support structure.

In certain implementations, the rotary member of the valve position sensor includes a transmitter and the fixed member of the valve position sensor includes a receiver of the valve position sensor. In some implementations, the fixed member includes a sensor connector that includes an attachment member, such as one or more barbs, that engages with an interior surface of a cavity in the fixed member and the sensor connector has an opening adapted to receive a sensor, such as a printed circuit board adapter that include at least a transmitter and/or receiver of the sensor.

In some implementations, the valve position sensor is comprised of a sensor from the group consisting of: a magnetic sensor, an electromagnetic sensor, an optical sensor, a hall effect sensor, a mechanical contact sensor and a radio frequency sensor. In certain implementations, the exhaust valve assembly includes a printed circuit board adapter that includes at least a portion of the valve position sensor and is affixed to a portion of the valve.

In certain implementation, an inflatable support system includes: an inflatable support structure configured to support a person, such as a bed mattress with inflatable cells that are connected to form support regions, such as four regions. As such four tubes are provided to the fixed portion of the valve. The inflatable support system includes a manually actuatable fluid exhaust valve, such as a manually actuatable CPR valve, configured to exhaust fluid from the inflatable support structure when the fluid exhaust valve is in an open position. The manually actuatable fluid exhaust valve includes a housing having a manually movable portion that moves the exhaust fluid valve, and a valve state position sensor configured to detect at least an open valve position of the fluid exhaust valve in response to manual actuation of the movable portion of the housing and send a signal in response to an open position of the fluid exhaust valve indicating a deflation action and to detect a closed position of the exhaust valve indicating an inflation action for the inflatable support structure. In some implementations, the valve state position sensor is located in multiple portions of the housing.

In certain implementations, the inflatable support system includes a controller, operatively coupled to the valve state position sensor, operative to shut off a fluid pump coupled to provide fluid to the inflatable support structure, in response to the signal indicating the deflation action for the inflatable support structure and operative to start fluid supply to the inflatable support structure in response to a signal from the valve state position sensor indicating closure of the valve.

In some implementations, the controller initiates an alarm in response to the signal indicating the deflation action for the inflatable support structure. In certain implementations, the manually movable portion of the exhaust valve includes a first portion and a second portion movable relative to each other to provide an open valve position and wherein the valve state position sensor is configured to detect an open valve position in response to movement between the first portion and the second portion.

In some implementations, the first portion includes a rotary member and the second portion includes a fixed member connected with one or more fluid tubes of the inflatable support structure, the rotary member being rotatable relative to the fixed member about a rotation axis and having at least one fluid output port configured to release fluid from the at least one fluid tube in response to rotation of the rotary member causing the open valve position and wherein the rotary member comprises at least a first portion of the valve state position sensor and the fixed member comprises a second portion of the valve state position sensor. In certain implementations, the rotary member and fixed member include a cam structure with biasing member that causes the valve to only be in either one of an opened or a closed position.

In other implementations, the valve includes a pull valve and in other implementation the exhaust valve includes a ball valve. However, any suitable manually actuatable exhaust valve may be employed.

In some implementations, the rotary member includes a transmitter of the valve state position sensor and the fixed member includes a receiver of the valve state position sensor. However the transmitter and receiver may be on any suitable portion of the valve housing or other member. In certain implementations, the fixed member includes a sensor connector that includes an attachment member that engages with an interior of a surface of a cavity in the fixed member and wherein the sensor connector has an opening adapted to receive a sensor.

In some implementations, the controller is configured to provide a fail-safe mode that maintains the inflatable support structure in an inflated state when an undesired signal level is detected from the valve state position sensor.

In certain implementations, a support system, such as a bed, includes: a frame; an inflatable support structure, such as an inflatable mattress, supported by the frame; a fluid pump operatively coupled to provide fluid to the inflatable support structure and a manually actuatable fluid exhaust valve configured to exhaust fluid from the inflatable support structure when the fluid exhaust valve is in an open position, comprising a housing having a manually movable portion that moves the exhaust fluid valve, and a valve state position sensor configured to detect at least an open valve position of the fluid exhaust valve in response to manual actuation of the movable portion of the housing and send a signal in response to an open position of the fluid exhaust valve indicating a deflation action and to detect a closed position of the exhaust valve indicating an inflation action for the inflatable support structure. The system includes a controller operatively coupled to the fluid pump and to the manually actuatable fluid exhaust valve, and operative to shut off the fluid pump, in response to the signal indicating the deflation action for the inflatable support structure and operative to start fluid supply to the inflatable support structure in response to a signal from the valve state position sensor indicating closure of the valve.

In some implementations, a method for controlling an inflatable support apparatus includes detecting, in response to a signal from a valve position sensor on a manually actuatable exhaust fluid valve that is configured to release all fluid in the inflatable support apparatus, an open position of the exhaust fluid valve. The method includes shutting off a fluid pump coupled to provide fluid to the inflatable support apparatus, in response to the signal indicating the deflation action for the inflatable support apparatus and starting fluid supply to the inflatable support apparatus in response to closure of the exhaust fluid valve.

In some implementations, the method includes initiating an alarm in response to the signal indicating the deflation action for the inflatable support apparatus. In certain implementations, the method includes providing a fail-safe mode that maintains the inflatable support apparatus in an inflated state when an undesired signal level is detected from the valve position sensor.

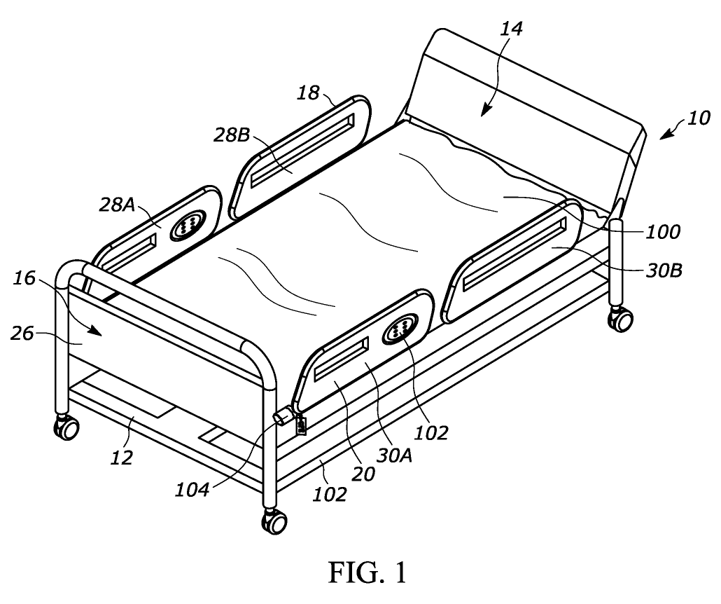

According to some embodiments as shown in FIG. 1, an inflatable support system such as an exemplary bed 10 is shown. Bed 10 includes a bed frame 12. The bed frame 12 having a foot end 14, a head end 16, a first side 18 and a second side 20. A footboard 24 is positioned at the foot end 14 of the bed frame 12. A headboard 26 is positioned at the head end 16 of bed frame 12. A plurality of side barriers 28A and 28B are positioned along the first side 18 of bed frame 12. A plurality of side barriers 30A and 30B are positioned along the side of bed frame 12. Exemplary side barriers include side rails and other exemplary members to prevent egress of a patient.

A patient support surface 100 is supported on bed frame 12 and is configured to support a person. As shown in FIG. 1, patient support surface 100 is positioned between side barriers 28 and side barriers 30 and between footboard 24 and headboard 26. A controller 40 is also supported 10 by bed frame 12. The controller 40 interacts with one or more components of patient support surface 100 through an interface 102.

The controller 40 is any suitable programmable controller, processor, device, apparatus, and/or other logic circuitry configuration used to control one or more operations of the patient support surface 100. In this example, the controller includes a housing that includes a user interface, air pump, circuitry, valves and other components to control a patient support. For example, the controller 40 is configured to inflate and/or deflate one or more inflatable portions of the patient support surface 100 using one or more programmed processors, application specific integrated circuits, or other suitable logic circuitry. By inflating and/or deflating the inflatable portions, the controller 40 is configured to control aspects the patient support surface 100. The controller 40 uses interface 102 to receive user inputs to control for example, the width, length, and/or height of the patient support surface 100 or other operations of the support surface. It will be recognized that any suitable support surface and bed frame may be employed.

In some instances, the controller 40 and/or the user interface device 104 is separated from patient support 35 surface 100 and/or each other. For example, another device such as a mobile device, nurse station computer, in-room computer, may include the user interface device 104. The other device receives user inputs and/or selections and then wirelessly provides the user inputs to the controller 40.

According to embodiments of the present disclosure, the support surface 100 includes a manually actuatable exhaust fluid valve 104 with a valve state position sensing that senses whether a valve in the manually actuatable exhaust fluid valve 104 is open or closed and sends one or more valve state position signals to the controller 40 indicating the valve open or closed position of the manually actuatable exhaust fluid valve 104. The controller 40 controls a fluid source, such as a fluid pump that provides fluid to the inflatable support surface 100, to shut off the fluid pump when the manually actuatable exhaust fluid valve 104 is open as further set forth below.

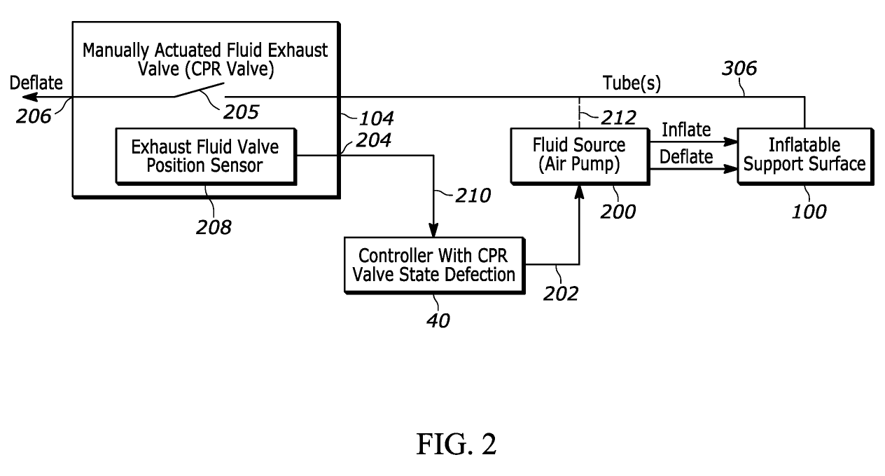

Referring to FIG. 2, a block diagram illustrates an example of a support system according to an embodiment of the present disclosure that includes a fluid source 200 that provide fluid to the inflatable support surface 100 under control from the controller 40. In this example, the support surface 100 includes a valve group (not shown), as known in the art, such as a set of solenoid controller valves that provide fluid to and from inflatable cells of the support surface and allow the support surface to deflate to atmosphere during normal operation. In this example, the manually actuatable exhaust fluid valve 104 includes an input fluid port 204 a manually actuatable valve structure 205, an exhaust (output) fluid port 206 and a fluid exhaust valve state position sensor 208. When the valve structure 205 is manually opened, the exhaust fluid port 206 exhausts the fluid from the inflatable fluid surface 100. The fluid exhaust valve state position sensor 208 provides an electronic valve state position signal 210 to the controller 40. In one example, in response to the valve state position signal 210 the controller sends a fluid source control signal 202 to shut off the fluid source 200 to prevent further inflation of the support surface 100. In some examples the inflatable surface is a low air loss surface, however, any suitable inflatable support surface may be used.

In one example, the gravitational force from the weight of the patient helps deflate the support surface 100 when the valve structure 205 is open. In other implementations, the fluid source is controlled by the controller 40 to also deflate (reverse the fluid pump) when a tube shown in dashed lines 212 is used as another exhaust path and the fluid source includes a controllable valve such as a stepper motor valve.

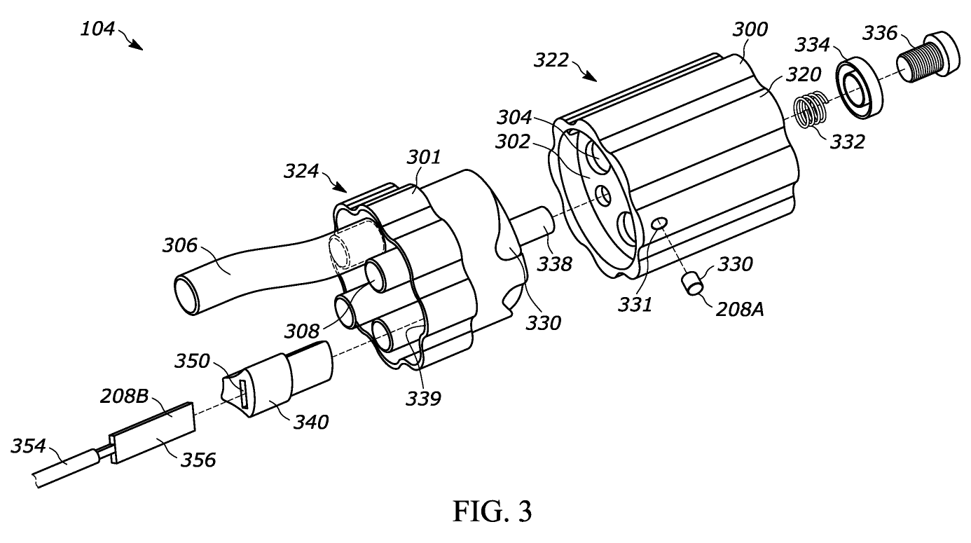

Referring also to FIG. 3, an exploded view of an example manually actuatable fluid exhaust valve 104, such as a CPR valve, is shown. However, it will be recognized that any suitable manually actuated CPR valve may be employed. In this example, a conventional rotary manually actuatable CPR valve is shown which has been modified to include the exhaust valve state positions sensor 208, shown in this example to include two portions 208A and 208B wherein one portion includes a signal source and one portion includes a receiver, however, any suitable valve state position sensor configuration may be employed including a transceiver on one portion of the housing.

The manually actuatable fluid exhaust valve 104 exhausts fluid from the inflatable support structure 100 when the fluid exhaust valve 104 is in an open position. In this example, the manually actuatable fluid exhaust valve 104 includes a housing having a manually movable portion 300 and a fixed portion 301. The manually moveable portion 300 has a valve face 302 with four openings 304 to respective channels. The four openings 304 movably align with corresponding openings 308 for tubes 306 (only one of four shown) that are affixed to the fixed portion 301. In operation depending on the direction of rotation, when a caregiver rotates the movable portion 300 90 degrees, the valve face 302 moves to cover the openings 308 to close the valve or moves to align with the openings 308 so that air from the tubes passes through the openings out channels 310 of the exhaust fluid valve to atmosphere. The valve state position sensor 208A and 208B is located to detect at least an open valve position of the fluid exhaust valve in response to manual actuation of the movable portion 300 of the housing and send a valve state position signal in response to an open position of the fluid exhaust valve indicating a deflation action for the controller. In one example this includes the controller send a shut off signal to the fluid pump. Also, in this example in response to rotation of the movable portion in the opposite direction, the sensor arrangement of 208A and 208B detects a closed position of the exhaust valve 104 indicating for the controller 40 that an inflation action should occur for the inflatable support structure. In one example this includes the controller sending a turn on signal to the fluid pump.

As such, the controller 40 shuts off the fluid pump coupled to provide fluid to the inflatable support structure, in response to the exhaust valve state signal indicating the deflation action for the inflatable support structure and starts the fluid supply to the inflatable support structure in response to a signal from the valve state position sensor indicating closure of the valve. In this example, the controller is also programmed to initiate an alarm, such as an audible or visual alarm on a user interface, such as interface 102, and/or a remote user interface, in response to the signal indicating the deflation action for the inflatable support structure so that the caregiver receives confirmation that the CPR valve is deflating the mattress.

It will also be recognized that the rotatable portion of the housing may also be fixed where for example the two parts of the housing are configured as an axially controlled valve versus a rotationally actuated valve.

Referring again to FIG. 3, in this example, the housing is plastic and the channels in the movable portion are defined by hand grippable contoured surfaces 320. In this example, there are four tube openings 308 and four corresponding valve openings 304 since there are four support regions provided in the mattress by inflatable cells as known in the art. However, one region can be provided or any suitable number of regions can be provided.

As shown the valve 104 includes in this example a finger grippable outer valve structure 322 on the movable portion and 324 on the fixed valve structure. In this example, a sensor element 330 is a magnet that is in opening 331 in an outer surface of the housing and serves as the portion 208A of the sensor 208. In other implementations, the sensor element is an electromagnet, switch, optical sensor or any suitable sensor configured to detect an open and closed position of the manually actuated exhaust valve.

The first portion 300 and a second portion 301 of the valve housing are movable relative to each other to provide an open valve position and a closed valve position. The valve state position sensor 104 is configured to detect an open valve position in response to movement between the first portion and the second portion. In the example shown, the first portion includes a rotary member 300 however a different structure such as a pull valve or ball valve may be used. The second portion includes the fixed member 301 connected with one or more fluid tubes 306 of the inflatable support structure 100. The rotary member 300 being rotatable relative to the fixed member about a rotation axis and having at least one fluid output port304 configured to release fluid from the at least one fluid tube in response to rotation of the rotary member causing the open valve position. In this example, the rotary member 300 includes at least a first portion 208A of the valve state position sensor 208 and the fixed member 301 includes a second portion 208B of the valve state position sensor. In this example, as known, the housing portions each include a complementary cam structure 330 (not shown for movable portion 300) with biasing member 332, such as a spring, positioned over protrusion 338 and held by a preloaded spring retainer 334 via screw 336, that when assembled, causes the movable member 300 to only be in either one of open or closed position.

Unlike conventional manually actuatable CPR valves, the valve shown in FIG. 3 includes the state position sensor mounted to the housing. In this example, the rotary member 300 houses a transmitter of the valve state position sensor and the fixed member 301 houses a receiver of the valve state position sensor. In this example, the fixed member 301 includes a receptacle area or cavity 339, that is adapted to receive a sensor connector 340. In one example the connector is sized to press fit into a curved portion of the grippable surface. This allows the sensor to be added to existing styled valves without requiring a remolding of the valve housing. In one example, the connector 340 includes an attachment member, such as one or more protrusions such as one or more barbs or other structure that engages with an interior of a surface the receptacle area 339 and/or an outer surface of the hose in the fixed member. In the example shown, the sensor connector 340 has an opening 350 adapted to receive a sensor 208B. In this example, the connector 340 is a printed circuit board (PCB) adapter that is press fit into cavity 339 or may be screwed in, glued, or attached in any suitable manner. The sensor 208B in this example is mounted on a PCB 356 that fits in the opening 350 and includes circuitry for processing the sensor signal and includes cable wiring 354 for a 4 wire cable in this example, however any suitable electrical connection to the controller may be employed. In this example the PCB includes a hall-effect sensor mounted to an end of the PCB that senses the magnetic field of the magnet 330 when they are aligned in the fixed and moveable portions such that when the valve is in a closed position, the sensor does not output a signal. However, when the valve is open, the sensor portions align and a signal is sent to the controller. The valve state position sensor in some implementations is a sensor from the group consisting of: a magnetic sensor, an electromagnetic sensor, an optical sensor, a hall effect sensor, a mechanical contact sensor and a radio frequency sensor. However, any suitable sensor configuration and technology may be used.

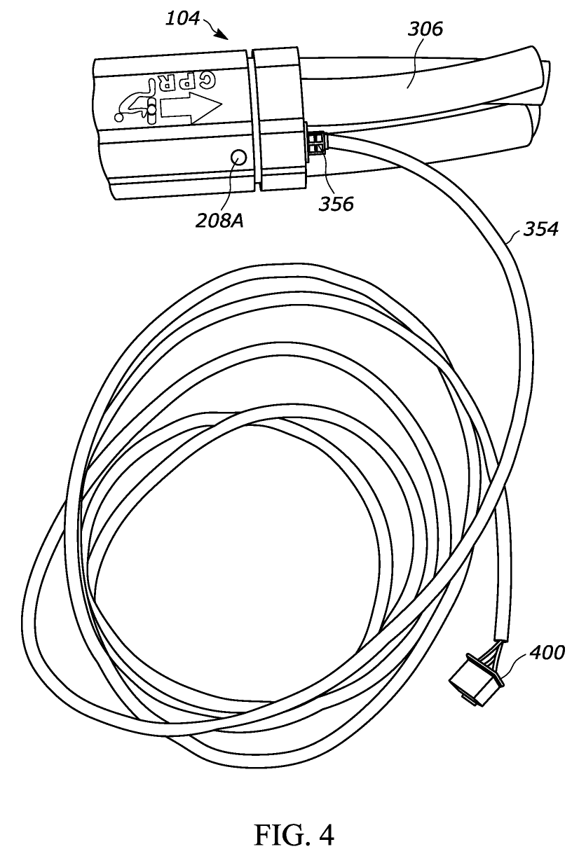

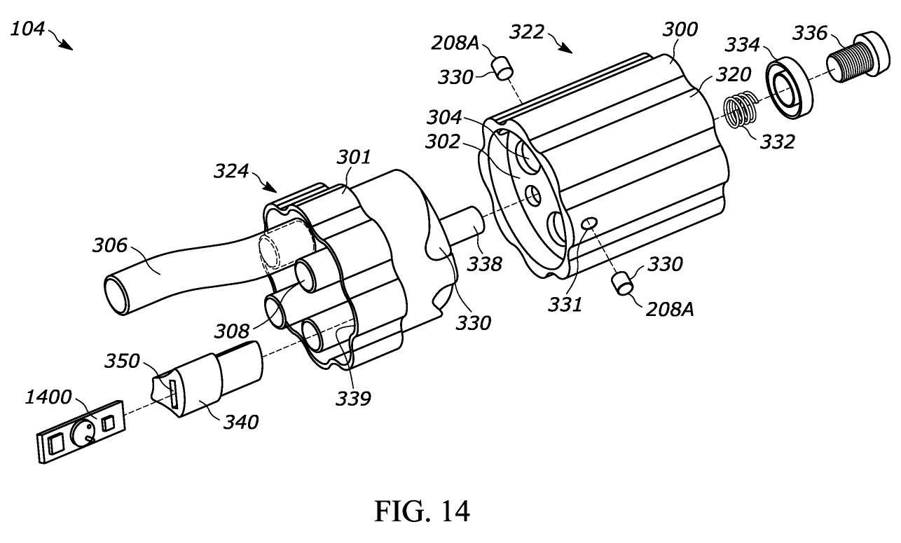

FIG. 4 is a perspective view of an example manually actuatable fluid exhaust valve and sensor connector cable according to an embodiment of the present disclosure. As shown, the PCB 356 and hence sensor portion 208B is aligned with sensor portion 208A and in this arrangement the sensor would produce a signal indicating an open valve position or CPR activation. The cable 354 has a connector 400 that connects to the PCB housing the controller 40. In other implementations, a wireless arrangement (FIG. 14) may be constructed with a battery-powered transmitter, using a wireless standard such as Bluetooth in lieu of cable 354 of FIG. 4.

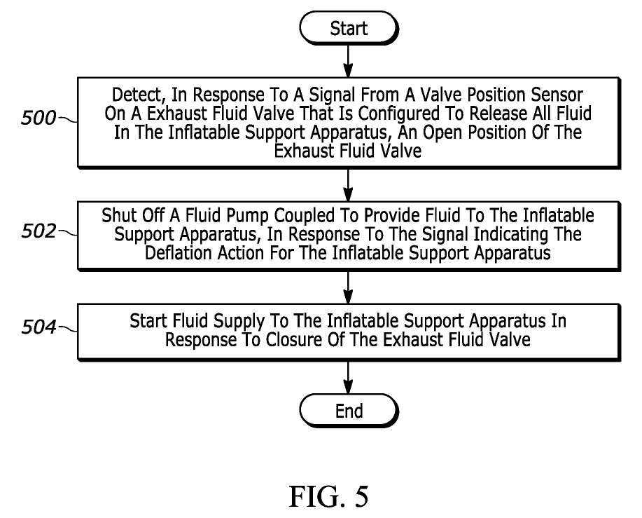

FIG. 5 is a flow chart illustrating an example method for controlling an inflatable support apparatus according to an embodiment of the present disclosure. In this example the operations are performed by the controller 40. As shown in block 500 the method includes detecting, in response to a signal from a valve position sensor on a manually actuatable exhaust fluid valve that is configured to release all fluid in the inflatable support apparatus, an open position of the exhaust fluid valve. As shown in block 502, the method includes shutting off a fluid pump coupled to provide fluid to the inflatable support apparatus, in response to the signal indicating the deflation action for the inflatable support apparatus. For example, the controller sends control signal 202 to the fluid pump causing the fluid pump to shut off. As shown in block 506, the method includes starting the fluid supply to the inflatable support apparatus in response to closure of the exhaust fluid valve. For example, the controller sends control signal 202 to the fluid pump causing the fluid pump to turn back on for normal operation.

The method also includes in some implementations, the controller initiating an alarm in response to the signal indicating the deflation action for the inflatable support apparatus. The method also includes in some implementations: providing a fail-safe mode that maintains the inflatable support apparatus in an inflated state when an undesired signal level is detected from the valve position sensor. For example, the controller checks the signal 202 to confirm that it has a valid signal level or checks other criteria to avoid entering a CPR deflation mode when there is not in fact one.

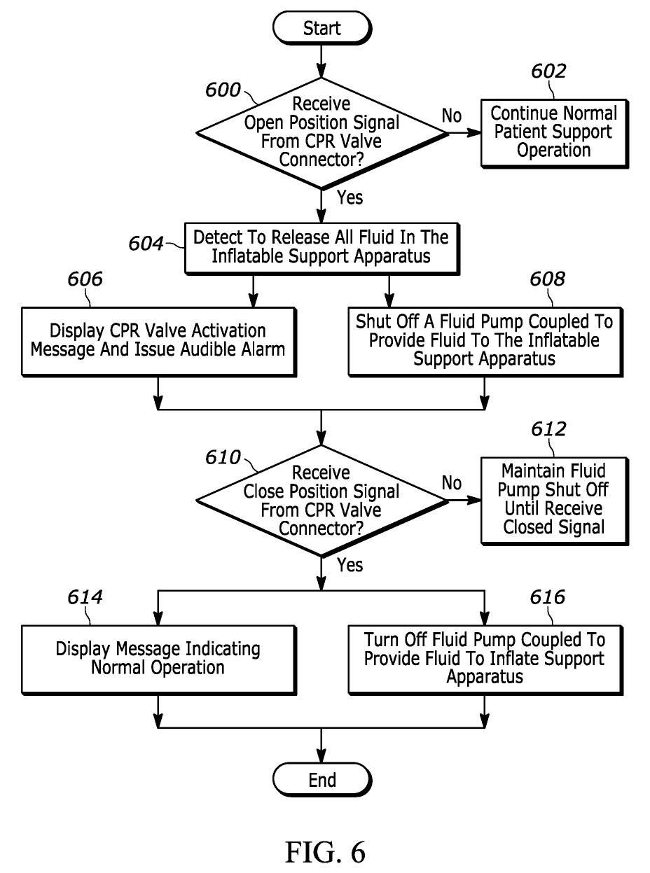

FIG. 6 is a flow chart illustrating an example method for controlling an inflatable support apparatus according to an embodiment of the present disclosure. In this example the operations are performed by the controller 40. As shown in block 600, the method includes receiving an open positional signal from the CPR valve connector. If no open position signal has been received, as shown in block 602 the method includes continuing normal patient support operation. However, if the controller receives a signal indicating that the CPR valve is open, as shown in block 604, the method includes detecting to release all fluid in the inflatable support apparatus. As shown in block 606 the method includes displaying a CPR valve activation message on a user interface and issuing an audible alarm indicating that the CPR mode has been activated. As shown in block 608 the method includes shutting off a fluid pump that is coupled to provide fluid to the inflatable support apparatus. As shown in block 610, the method includes determining whether the controller received a closed position signal from the CPR valve connector. If no signal has been received indicating that the CPR valve is closed, as shown in block 612 the method includes maintaining shut off of the fluid pump until a closed valve signal is received. As shown in block 614 when the closed position signal is received indicating that the CPR valve is closed, the controller displays a message indicating normal operation is occurring. As shown in block 616, the method includes turning on the fluid pump to the support app support apparatus to provide fluid to inflate the support apparatus to begin normal operation.

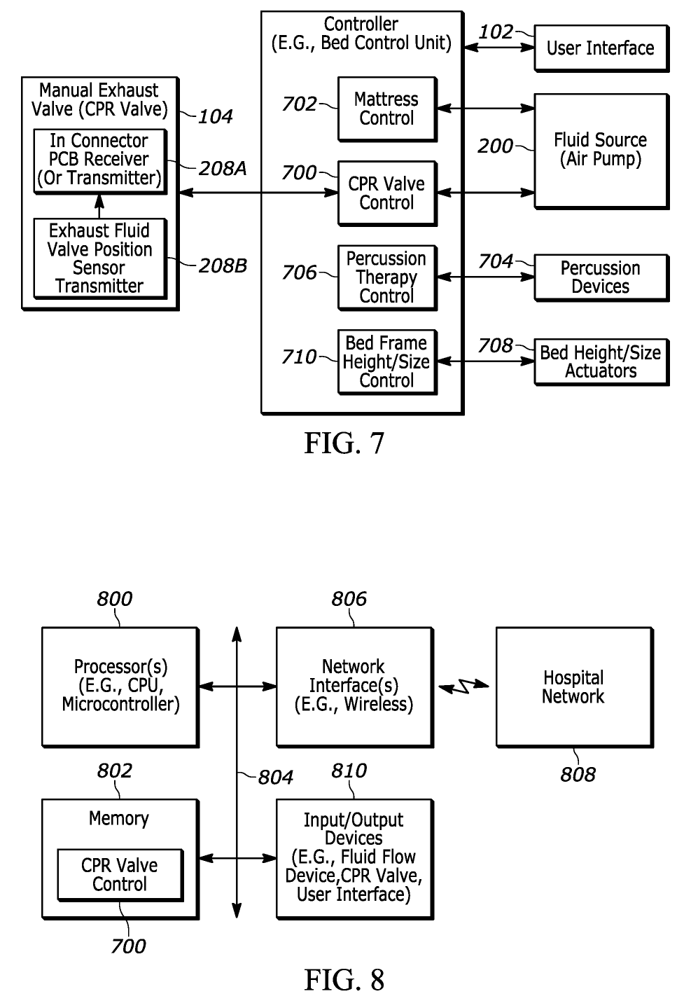

FIG. 7 is a block diagram illustrating an example system according to an embodiment of the present disclosure. In this example, the controller is in the form of a bed control unit. The controller is programmed to have multiple different executable code modules that when executed cause the controller to carry out operations. In this example the controller includes the CPR valve control operation 700 as previously described and in addition includes a normal mattress control operation 702 such as controlling inflatable mattress cells in various parts of the mattress during normal operations as known in the art. In this example the support system also includes percussion therapy devices 704 which are controlled through a percussion therapy control operation 706, is known in the art. Similarly in this example the bed includes bed height and size actuators 708 which are controlled by bed frame height and size control operations 710.

FIG. 8 is a block diagram illustrating an example system according to an embodiment of the present disclosure. When the controller is implemented as one or more processors such as a programmable central processing unit or programmable microcontroller shown as 800, the controller includes memory 802 that stores executable instructions that when executed cause the processor to operate as described herein. The memory as noted above may include for example RAM, ROM, or any other suitable memory. The controller operation referred to as CPR valve control 700 is stored in memory as executable instructions that are executed by the processor 800 through one or more buses 804. The controller if desired can include one or more network interfaces 806 to wirelessly communicate for example to a hospital computer network 808 and include input/output devices 810 such as the CPR valve 104, fluid source 200, user interface 102, and other devices.

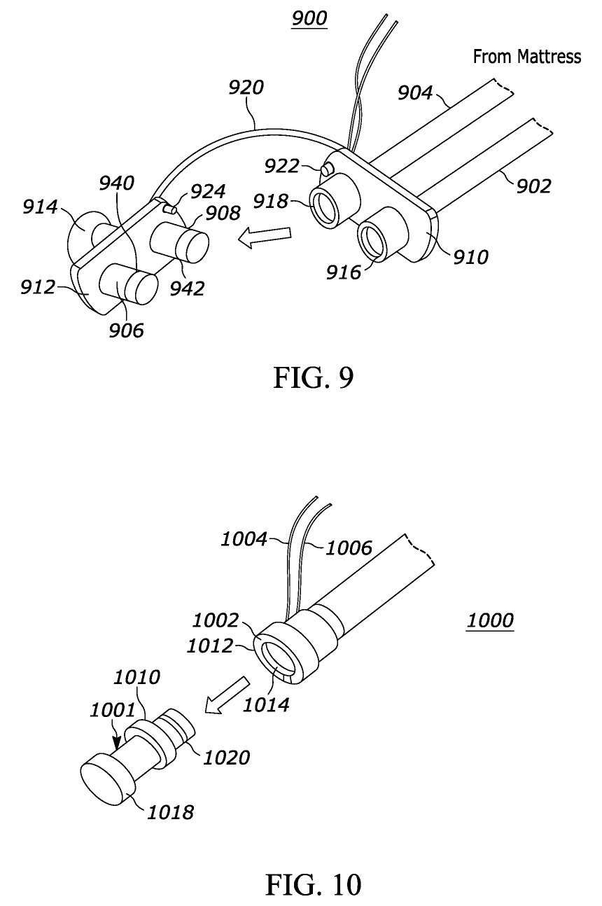

FIG. 9 illustrates another example of a manually actuatable fluid exhaust valve. In this example the manually actuatable fluid exhaust valve 900 is a pull valve with a valve position sensor. In this example, exhaust tubes 902 and 904 from the mattress are sealed using pull plugs 906 and 908 that plug into a connector 910 that has a fluid connection with the tubes 902 and 904. In this example each of the plugs 906 and 908 are attached to a connector 912 that has a knob 914 that is used to pull the plugs 906 and 908 from the connector 910. The plugs 906 and 908 in some implementations are configured as quick disconnect connectors that includes a gasket 940 and 942 on a shaft of each the plug that engages with inner surfaces of corresponding female connector portions 916 and 918, to form a fluid seal for the tubes 902 and 904. In other examples the plugs are made of rubber or any other suitable material that frictionally engages with inner surfaces of corresponding female connector portions 916 and 918, to form a fluid seal for the tubes 902 and 904. In this example a securing leash 920 is attached to both the connector 910 and 912. In this example a valve position sensor 922 senses whether the plugs 906 and 908 are forming a seal with female portions 916 and 918. In some implementations, the sensor 922 makes contact with the corresponding position sensor 924 when the plugs 906 and 908 are inserted into the female portions 916 and 918 and send a signal indicating that the valve is closed. The fluid sensor 922 can include position sensors as previously described above so that the controller receives the signal indicating whether the valve is open or closed. For example, the position sensor can include a mechanical contact switch, an optical signal sensor, or other suitable sensor as described above. When the knob is pulled, the fluid in the exhaust tubes 902 and 904 is released during a CPR event and the valve position sensor indicates to the controller that the valve is in an open position and the controller operates as previously described above. It will be recognized that any suitable number of exhaust tubes maybe employed as desired.

FIG. 10 illustrates another example of a manually actuatable fluid exhaust valve. In this example the manually actuatable fluid exhaust valve 1000 is a pull valve with a valve position sensor. In this example, a pair of conductive metal rings 1010 and 1012, one on a plug portion 1001 and one on an exhaust tube portion 1002 form a short circuit when in contact when the plug portion is inserted into a female receptable 1014 of the exhaust tube portion 1002. For example, a conductive metal ring 1012, such as a “c” shaped conductive ring, has corresponding wires 1004 and 1006 that provide a signal to the controller. The conductive metal ring 1010 is shaped as an “o”. The controller provides a low voltage to the wires such that when the conductive ring 1010 makes contact with the conductive ring 1012 a short circuit voltage level is provided (closed valve position) and when the plug portion 1001 is pulled to release the fluid from the exhaust tube portion 1002 an open signal voltage level is provided to the controller signaling an open valve position. In this example, the plug portion 1001 includes a knob portion 1018 and a quick disconnect valve configuration that includes a gasket 1020 on a shaft of the plug portion, however any suitable connection arrangement may be employed. It will be recognized that any suitable number of exhaust tubes may be employed as desired.

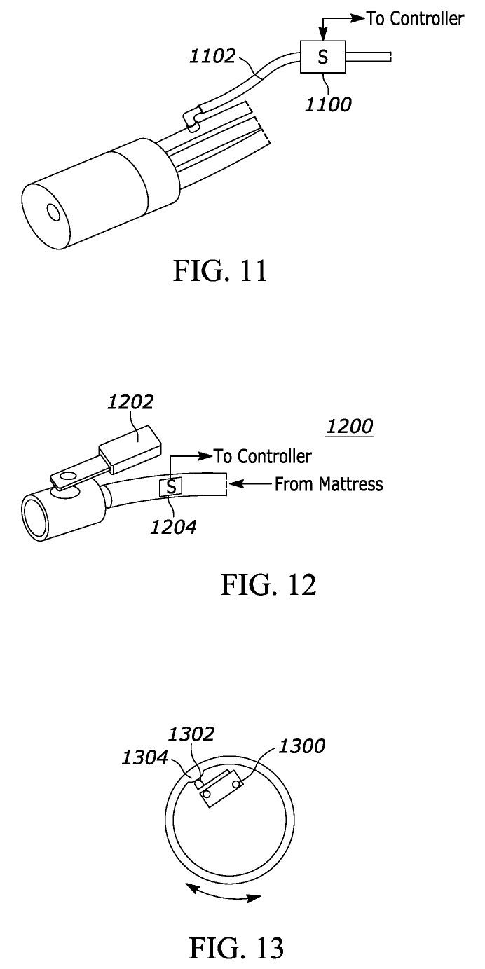

FIG. 11 illustrates another embodiment where the manually actuatable fluid exhaust valve is a rotational valve similar to the one in FIG. 3 but has a valve position sensor that is not on a housing portion of the valve. In this example a conventional CPR valve is used and a pressure sensor 1100, such as an air flow sensor, is fluidly connected to one or more of the exhaust tubes so that valve position sensors are not needed in the valve housing. In this example the pressure sensor is not in the rotatable portion or fixed portion of the fluid exhaust valve. In this example, the pressure sensor 1100 is positioned to sense a low pressure level in one or more fluid exhaust tubes as compared to a desired threshold pressure that is stored in memory of the controller. In one example a signal from the pressure sensor 1100 indicating a pressure level in the exhaust tube is detected by the controller. The controller waits a period of time, after sensing a low pressure level from the pressure sensor before a CPR event is signaled, to avoid false detections such as when a patient exits the mattress. For example, the weight of the patient won’t affect the pressure at the CPR discharge valve, which will be approximately atmospheric when open, but when a patient exits the mattress, (and CPR valve is not open) the pressure sensed will temporarily also be atmospheric until the pump refills and re-pressurizes the mattress. The pressure sensor can be employed with any suitable CPR exhaust valve structure such as rotating valves, ball valves, pull plugs or any other suitable CPR exhaust valve. In some implementations the sensor 1100 may be located in the housing that housing the controller circuitry. In some implementations, the sensor is located within an exhaust tube. In other implementations a separate pressure sense hose 1102 is attached to an exhaust tube and is provided to the control unit that contains the controller and sensor 1100.

As shown, the manually actuatable fluid exhaust valve includes a pressure sensor, or an air flow sensor, in one or more of the exhaust tubes so that valve position sensors are not needed in the rotatable housing or fixed portion of the fluid exhaust valve. In this example, the flow sensor detects air flow resulting from the open CPR valve.

FIG. 12 illustrates another example of a manually actuatable fluid exhaust valve. In this example the manually actuatable fluid exhaust valve 1200 includes a ball valve with a handle 1202 to rotate a ball valve and a valve position sensor, such as a flow sensor 1204 fluidly connected to the exhaust tube.

FIG. 13 is a cross-sectional view of a manually actuatable fluid exhaust valve according to an embodiment of the present disclosure. In this example, the valve is rotatable similar to FIG. 3 and includes a mechanical switch 1300 (e.g., a micro switch) has an arm 1302 that when pressed in sends a signal to the controller indicating that the valve is open. The arm 1302 has a portion that engages with a bump 1304 on an inner surface as the rotatable housing. The mechanical switch 1300 is fixedly attached to a non-moving portion of the valve housing.

FIG. 14 illustrates another example of a manually actuatable fluid exhaust valve. In this example the manually actuatable fluid exhaust valve includes a wireless radio-frequency transmitter 1400, such as a Bluetooth compatible transmitter or any other suitable wireless transmitter that sends the control signal to the controller instead of communicating the signal through wiring 354. In this example, the wiring 354 is eliminated and the controller includes a corresponding wireless receiver or transceiver that is configured to suitably receive the wireless control signal transmitted by the transmitter 1400.

Also in another example, two sensor magnets 330 are spaced apart 180 degrees on the manually movable portion 300. In this example, the additional sensor magnet is added to allow for full rotation of the barrel if the barrel (movable portion) is designed to fully rotate more than 90 degrees. It will be recognized that any suitable number of sensors may be employed.

As set forth herein, a system is disclosed that includes a fluid inflatable support such as an inflatable mattress, a plurality of inflatable cells, in fluid communication with a fluid flow generating device (e.g. blower or pump) that includes an electronic controller. The manually activated exhaust evacuation valve is coupled to the fluid flow generating device and the fluid inflatable support product. The manually activated valve includes a fluid port that is open or closed by a valve in response to manual activation of at least a portion of the valve, a valve position sensor is configured to sense an open or closed position of the manually actuated valve. In some implementations, a position sensor is mounted to the valve housing and in other examples, the position sensor is fluidly connected to one or more exhaust valve to sense a low pressure condition or rapid change in pressure or flow condition. The electronic controller is operative to electronically control the blower in response to an electronic signal from the sensor. Among other advantages, the valve position sensor as part of the smart CRP valve provides a switch mechanism for a manually actuatable CPR valve that sends a valve position signal for fast turn off or turn on of the blower or control unit without user interference. A caregiver can instead focus on providing critical CPR care for the patient.

Having described the many embodiments of the present disclosure in detail, it will be apparent that modifications and variations are possible without departing from the scope of the disclosure defined in the appended claims. Furthermore, it should be appreciated that all examples in the present disclosure, while illustrating many embodiments of the disclosure, are provided as non-limiting examples and are, therefore, not to be taken as limiting the various aspects so illustrated. Accordingly, it is intended that the present disclosure not be limited to the described embodiments, but that it has the full scope defined by the language of the following claims, and equivalents thereof.

What is claimed is:

1. An inflatable support system comprising:
an inflatable support structure configured to support a person; and
a manually actuatable fluid exhaust valve configured to exhaust fluid from the inflatable support structure when the fluid exhaust valve is in an open position, comprising a housing having a manually movable portion that moves the exhaust fluid valve, and a valve state position sensor configured to detect at least an open valve position of the fluid exhaust valve in response to manual actuation of the movable portion of the housing and send a signal in response to an open position of the fluid exhaust valve indicating a deflation action and to detect a closed position of the exhaust valve indicating an inflation action for the inflatable support structure.

2. The inflatable support system of claim 1 comprising a controller, operatively coupled to the valve state position sensor, operative to shut off a fluid pump coupled to provide fluid to the inflatable support structure, in response to the signal indicating the deflation action for the inflatable support structure and operative to start fluid supply to the inflatable support structure in response to a signal from the valve state position sensor indicating closure of the valve.

3. The inflatable support system of claim 2 wherein the controller is operative to initiate an alarm in response to the signal indicating the deflation action for the inflatable support structure.

4. The inflatable support system of claim 1 wherein the manually movable portion of the exhaust valve comprises a first portion and a second portion movable relative to each other to provide an open valve position and wherein the valve state position sensor is configured to detect an open valve position in response to movement between the first portion and the second portion.

5. The inflatable support system of claim 4 wherein the first portion comprises a rotary member and the second portion comprises a fixed member connected with one or more fluid tubes of the inflatable support structure, the rotary member being rotatable relative to the fixed member about a rotation axis and having at least one fluid output port configured to release fluid from the at least one fluid tube in response to rotation of the rotary member causing the open valve position and wherein the rotary member comprises at least a first portion of the valve state position sensor and the fixed member comprises a second portion of the valve state position sensor.

6. The inflatable support system of claim 5 wherein the rotary member comprises a transmitter of the valve state position sensor and the fixed member comprises a receiver of the valve state position sensor.

7. The inflatable support system of claim 5 wherein the fixed member comprises a sensor connector that comprises an attachment member that engages with an interior of a surface of a cavity in the fixed member and wherein the sensor connector has an opening adapted to receive a sensor.

8. The inflatable support system of claim 1 wherein the valve state position sensor is comprised of a sensor from the group consisting of: a magnetic sensor, an electromagnetic sensor, an optical sensor, a hall effect sensor, a mechanical contact sensor, a fluid pressure sensor, and a radio frequency sensor.

9. The inflatable support system of claim 1 wherein the controller is configured to provide a fail-safe mode that maintains the inflatable support structure in an inflated state when an undesired signal level is detected from the valve state position sensor.

10. A support system comprising:
a frame;
an inflatable support structure supported by the frame;
a fluid pump operatively coupled to provide fluid to the inflatable support structure;
a manually actuatable fluid exhaust valve configured to exhaust fluid from the inflatable support structure when the fluid exhaust valve is in an open position, comprising a housing having a manually movable portion that moves the exhaust fluid valve, and a valve state position sensor configured to detect at least an open valve position of the fluid exhaust valve in response to manual actuation of the movable portion of the housing and send a signal in response to an open position of the fluid exhaust valve indicating a deflation action and to detect a closed position of the exhaust valve indicating an inflation action for the inflatable support structure; and
a controller operatively coupled to the fluid pump and to the manually actuatable fluid exhaust valve, and operative to shut off the fluid pump, in response to the signal indicating the deflation action for the inflatable support structure and operative to start fluid supply to the inflatable support structure in response to a signal from the valve state position sensor indicating closure of the valve.

11. The support system of claim 10 wherein the manually movable portion of the exhaust valve comprises a first portion and a second portion movable relative to each other to provide an open valve position and wherein the valve state position sensor is configured to detect an open valve position in response to movement between the first portion and the second portion.

12. The support system of claim 11 wherein the first portion comprises a rotary member and the second portion comprises a fixed member connected with one or more fluid tubes of the inflatable support structure, the rotary member being rotatable relative to the fixed member about a rotation axis and having at least one fluid output port configured to release fluid from the at least one fluid tube in response to rotation of the rotary member causing the open valve position and wherein the rotary member comprises at least a first portion of the valve state position sensor and the fixed member comprises a second portion of the valve state position sensor.

13. A fluid exhaust valve assembly comprising:
an exhaust valve housing comprising a manually rotatable member and a fixed member, the fixed member configured to couple with a plurality of fluid tubes of an inflatable support structure, the manually rotatable member being rotatable relative to the fixed member about a rotation axis and having at least one fluid output port configured to release fluid from the plurality of fluid tubes in response to rotation of the rotary member causing an open valve position and the exhaust valve housing comprising a valve state position sensor operative to provide a signal in response to movement of the manually rotatable member indicating a an open valve position and deflation action for the inflatable support structure.

14. The fluid exhaust valve assembly of claim 11 the rotary member of the valve position sensor comprises a transmitter and the fixed member of the valve position sensor comprises a receiver of the valve position sensor.

15. The fluid exhaust valve assembly of claim 11 wherein the fixed member comprises a sensor connector that comprises an attachment member that engages with an interior of a surface of a cavity in the fixed member and wherein the sensor connector has an opening adapted to receive a sensor.

16. The fluid exhaust assembly of claim 11 wherein the valve position sensor is comprised of a sensor from the group consisting of: a magnetic sensor, an electromagnetic sensor, an optical sensor, a hall effect sensor, a mechanical sensor, a pressure sensor and a radio frequency sensor.

17. The fluid exhaust valve assembly of claim 11 wherein the exhaust valve assembly comprises a printed circuit board adapter that comprises at least a portion of the valve position sensor and is affixed to a portion of the valve.

18. A method for controlling an inflatable support apparatus comprising:
detecting, in response to a signal from a valve position sensor on a manually actuatable exhaust fluid valve that is configured to release substantially all fluid in the inflatable support apparatus, an open position of the exhaust fluid valve;
shutting off a fluid pump coupled to provide fluid to the inflatable support apparatus, in response to the signal indicating the deflation action for the inflatable support apparatus; and
starting fluid supply to the inflatable support apparatus in response to closure of the exhaust fluid valve.

19. The method of claim 18 comprising initiating an alarm in response to the signal indicating the deflation action for the inflatable support apparatus.

20. The method of claim 18 comprising providing a fail-safe mode that maintains the inflatable support apparatus in an inflated state when an undesired signal level is detected from the valve position sensor.
